(19) United States
(12) Patent Application Publication
(10) Pub. No.: US 2019/0294766 A1
(43) Pub. Date: Sep. 26, 2019

(54) AUTHENTICATION BASED ON DETERMINED PRIVACY LEVEL OF COMMAND

(71) Applicant: Lenovo (Singapore) Pte. Ltd., Singapore (SG)

(72) Inventor: David W. Douglas, Cary, NC (US)

(21) Appl. No.: 15/928,513

(22) Filed: Mar. 22, 2018

(51) Int. Cl. G06F 21/31

(52) U.S. Cl. CPC G06F 21/31; G06F 21/32

(57) ABSTRACT

One embodiment provides a method, including: receiving, at an information handling device, an audible command from a user; determining, using a processor, whether a privacy level associated with the audible command corresponds to one of a first privacy level and a higher privacy level; and responsive to determining that the privacy level corresponds to the higher privacy level, authenticating the user prior to performing a function associated with the audible command. Other aspects are described and claimed.

### BACKGROUND

Information handling devices (“devices”), for example smart phones, tablet devices, smart speakers, laptop and personal computers, and the like, may be capable of receiving command inputs and providing corresponding outputs or performing corresponding functions responsive to the inputs. Generally, a user interacts with a voice input module, for example embodied in a digital assistant through use of natural language. This style of interface allows a device to receive voice inputs from a user (e.g., queries, commands, etc.), process those inputs, and perform one or more corresponding output functions.

### BRIEF SUMMARY

In summary, one aspect provides a method, comprising: receiving, at an information handling device, an audible command from a user; determining, using a processor, whether a privacy level associated with the audible command corresponds to one of a first privacy level and a higher privacy level; and responsive to determining that the privacy level corresponds to the higher privacy level, authenticating the user prior to performing a function associated with the audible command.

Another aspect provides an information handling device, comprising: a processor; a memory device that stores instructions executable by the processor to: receive an audible command from a user; determine whether a privacy level associated with the audible command corresponds to one of a first privacy level and a higher privacy level; and responsive to determining that the privacy level corresponds to the higher privacy level, authenticate the user prior to performing a function associated with the audible command.

A further aspect provides a product, comprising: a storage device that stores code, the code being executable by a processor and comprising: code that receives an audible command from a user; code that determines whether a privacy level associated with the audible command corresponds to one of a first privacy level and a higher privacy level; and code that authenticates, responsive to determining that the privacy level corresponds to the higher privacy level, the user prior to performing a function associated with the audible command.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of authenticating a user prior to performing a function associated with a provided audible command.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices (e.g., smart phones, tablets, laptop and personal computers, smart speakers, etc.) to execute a variety of different commands or queries. As technology has advanced, the use of audible voice input for the provision of commands or queries has become more prevalent. Such an input method may be useful to users who are not in proximity to a device or who may have their hands or visual attention occupied with one or more objects or tasks.

Audible commands are generally received at a voice input module (e.g., a microphone, speech recognition device, another audio capture device, etc.) operatively coupled to a device. The nature of such an input methodology is that a user does not necessarily need to be “logged on” to their device, or to a specific profile on the device, to provide inputs and receive corresponding outputs. Rather, a user may simply provide their command input, or a wake word followed by the command input, after which a function corresponding to the command is performed. Such an input methodology may allow virtually any individual within vocal proximity of the device to provide audible inputs to the device, including individuals not actually authorized to use the device or authorized to be apprised of requested output.

Conventionally, authentication methods exist that may require a user to identify themselves (e.g., by providing a passcode or pass phrase, using biometric input, etc.) prior to performance of a corresponding function associated with the user command. However, such a blanket authorization requirement for all commands may result in slower processing and increased output times for many commands, including those commands that are not associated with sensitive or confidential information. For example, a user command to “provide the latest sports scores” is simply requesting access to public information. Requiring a user to authenticate themselves as the owner or licensee of the device processing such a request may be burdensome and unnecessary.

Accordingly, an embodiment provides a method for requiring user authentication only for commands determined to be associated with a high privacy level. In an embodiment, an audible command may be received at a device from a user. An embodiment may then determine whether a privacy level associated with an audible command corresponds to a low, or first, privacy level or a higher privacy level. Responsive to determining that the privacy level corresponds to the first privacy level, an embodiment may process the command without authorizing the command provider. Conversely, responsive to determining that the privacy level corresponds to a higher privacy level, an embodiment may authenticate the user prior to performing a function associated with the command. Such a method may increase the average output times of all commands by only performing authentication processes on commands associated with a higher privacy level.

The illustrated example embodiments will be best understood by reference to the figures. The following description is intended only by way of example, and simply illustrates certain example embodiments.

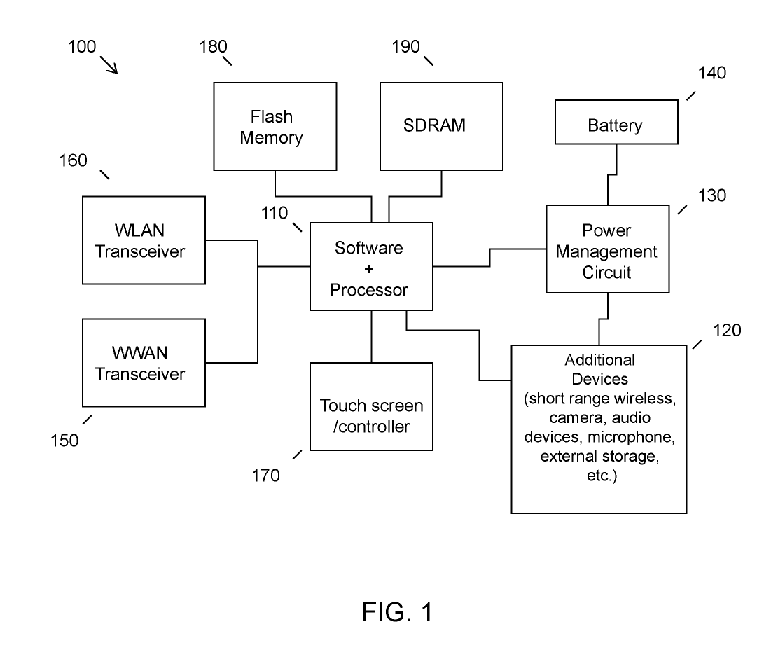

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes a touch screen 170 for data input and display/rendering. System 100 also typically includes various memory devices, for example flash memory 180 and SDRAM 190.

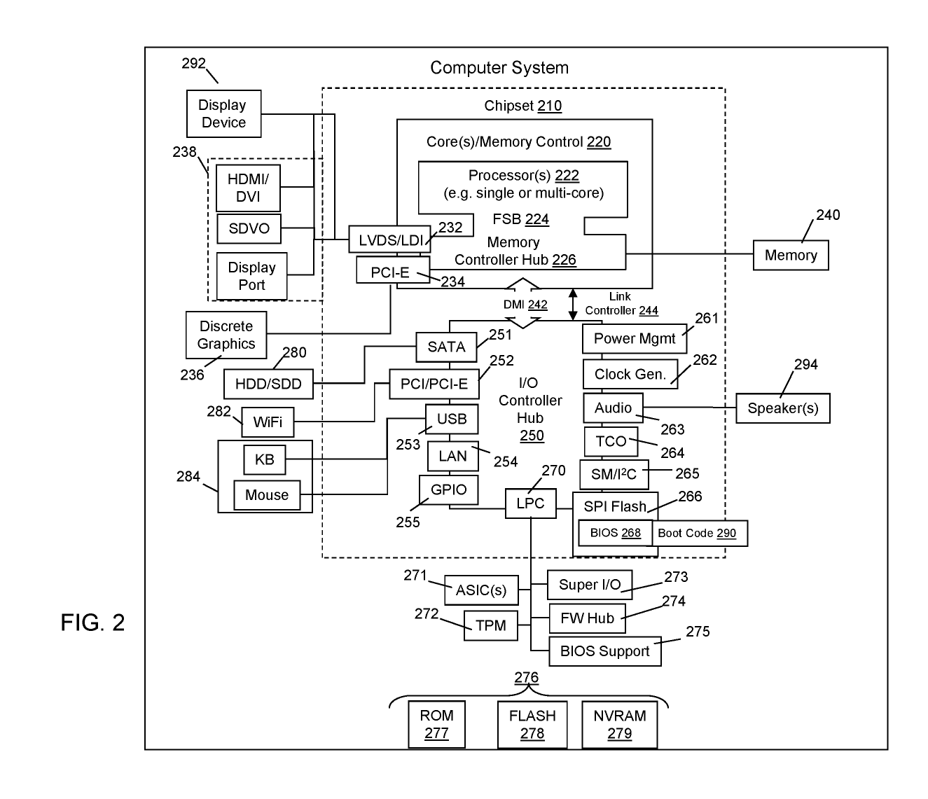

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAIVI 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

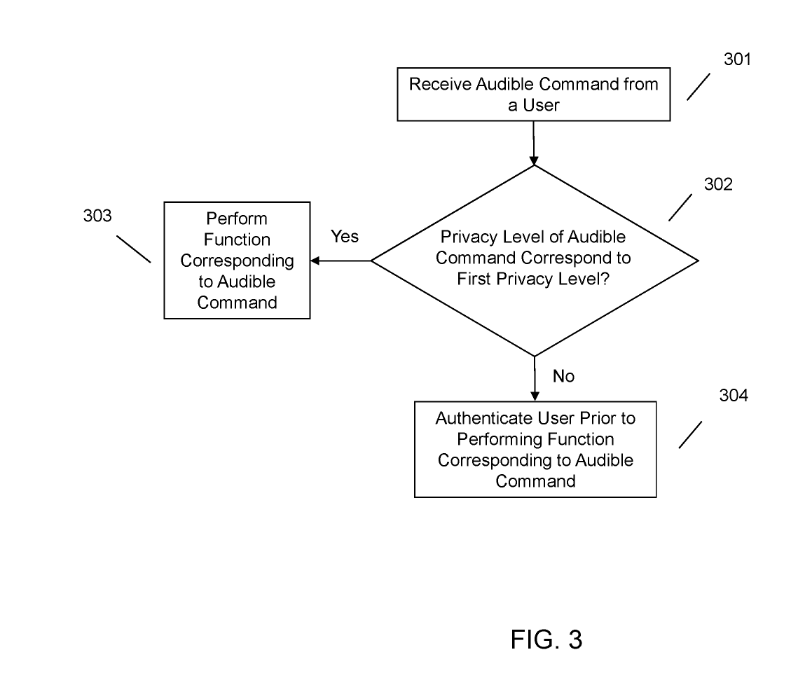

Referring now to FIG. 3, an embodiment may determine whether an audible command is associated with a privacy level requiring user authentication prior to performing a function associated with the audible command. At 301, an embodiment may receive an audible command from a user. The audible command may be virtually any command that demands performance of a corresponding function (e.g., the command may be a command to open an application, draft a message, recite a received communication, purchase an item, etc.). In an embodiment, the audible command may be received/detected by an input device (e.g., a microphone, an audio capture device, etc.) operatively coupled to or in communication with the device.

In an embodiment, the input device may be an input device integral to the device. For example, a smart phone may be disposed with a microphone capable of receiving voice input data. Alternatively, the input device may be disposed on another device and may transmit received voice input data to the device. For example, voice input may be received at a smart speaker that may subsequently transmit the voice data to another device (e.g., to a user's smartphone for processing, etc.). Voice input data may be communicated from other sources to the device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive voice input data by maintaining the input device in an active state. The input device may, for example, continuously detect voice input data even when other sensors (e.g., cameras, light sensors, speakers, other microphones, etc.) associated with the speech recognition device are inactive. Alternatively, the input device may remain in an active state for a predetermined amount of time (e.g., 30 minutes, 1 hour, 2 hours, etc.). Subsequent to not receiving any voice input data during this predetermined time window, an embodiment may switch the input device to a power off state. The predetermined time window may be preconfigured by a manufacturer or, alternatively, may be configured and set by one or more users.

At 302, an embodiment may determine whether a privacy level associated with the audible command corresponds to a low privacy level or a higher privacy level. In the context of this application, an audible command associated with a low privacy level may not require any user authentication or identification prior to executing a function associated with the command. According to an embodiment, a low privacy level command may be a command requesting the provision of information that is substantially publicly available (e.g., sports scores, weather updates, traffic updates, breaking news headlines, etc.), a command requesting performance of a non-sensitive function (e.g., activating an internet browser, changing the channel on a TV, etc.), and the like. Conversely, in the context of this application, a higher privacy level may be a privacy level that requires user authentication prior to executing a function that corresponds to the audible command. According to an embodiment, a higher privacy level command may be a command requesting the provision of information that is sensitive or confidential (e.g., bank account information, confidential work documents, received communications, etc.), a command requesting performance of a sensitive function (e.g., emailing a boss, conducting a financial transaction, deleting documents, etc.), and the like. In an embodiment, the designations regarding which types of commands correspond to lower or higher privacy levels may be set by a manufacturer or may be set and adjusted by a user.

An embodiment may identify which type of privacy level corresponds to the audible command by accessing one or more lists comprising a listing of domains, or keywords, and their corresponding privacy associations. An embodiment may then determine whether at least a portion of the audible command comprises at least one domain from the list(s). For example, a particular list may associate domain words such as “sports”, “scores”, “weather”, and “traffic” with a low-privacy level and associate domain words such as “buy”, “sell”, “boss”, “delete”, and “voice mail” with a higher-privacy level. Depending on the domain word or words identified in the audible command, an embodiment may increase or decrease the confidence required to perform a function associated with that command. Stated differently, higher privacy level-based commands would require a higher confidence that an authorized user is the provider of the command. Responsive to identifying that the confidence level of user authentication associated with an audible command is below a predetermined threshold, an embodiment may associate a low privacy level with that command. Conversely, responsive to identifying that the confidence level of user authentication associated with an audible command is above the predetermined threshold, an embodiment may associate a high privacy level with that command.

An embodiment may also distinguish between commands placed in the higher privacy level. More particularly, two or more commands may be associated with the higher privacy level but certain commands may be even more sensitive or confidential than others. For example, a command requesting that an email be sent to a user's boss and a command requesting purchase of an item may both be associated with a higher privacy level than the first privacy level, however, the command requesting purchase of an item may require greater confidence level of user authentication than the command requesting that an email be sent to a user's boss.

An embodiment may “rank” commands and place them in different higher privacy levels. The ranking of commands in the higher privacy level may be done using one or more methods. For example, if one command comprises more high privacy level domain words than another, an embodiment may require an increased confidence level of user authentication (e.g., via increased processing or analysis of an audible command, etc.). In another, similar example, certain domain words may be weighted greater than others. For example, domain words associated with financial transactions (e.g., “buy”, “sell”, etc.) may be assigned a greater confidence value than domain words such as “voice mail”. An embodiment may comprise one or more sub-thresholds in the higher privacy level that correspond to different levels of higher privacy. Each of the sub-thresholds may be associated with a particular confidence value.

Responsive to determining, at 302, that the audible command is associated with a first privacy level, an embodiment may perform, at 303, a function corresponding to the audible command. In an embodiment, the function may be performed without authenticating or identifying the command-providing user. Conversely, responsive to determining, at 302, that the audible command is not associated with the first privacy level, but rather, is associated with a higher privacy level, an embodiment may authenticate, at 304, the user prior to performing a function corresponding to the audible command.

In an embodiment, a user may be prompted (e.g., audibly, visually, a combination thereof, etc.) to provide user authentication input responsive to determining that the privacy level of the audible command is associated with a higher privacy level. The user authentication input may be, for example, biometric input (e.g. fingerprint data, eye data, etc.), password input, additional voice input (e.g., to be used for voice analysis, etc.), and the like. The received user authentication input may be compared against stored user authentication data to arrive at a determination regarding the identity of a command-providing user. Responsive to determining that the received user authentication input does not match stored user authentication data, an embodiment may not perform the corresponding function. Additionally and/or alternatively, an embodiment may notify the user that the authentication input does not match stored user authentication data (e.g., audibly, visually, a combination thereof, etc.).

In an embodiment, each higher privacy level may have different authentication requirements based upon an associated confidence level of the particular privacy level. For example, an audible command associated with the highest privacy level may require two or more types of authentication input (e.g., biometric input and password input, etc.) prior to performing the corresponding function. Conversely, a high privacy level with a lower confidence score may only require a single type of authentication input.

The various embodiments described herein thus represent a technical improvement to conventional output processing and user authentication techniques. Using the techniques described herein, an embodiment may receive an audible command from a user and thereafter determine whether a privacy level associated with the audible command corresponds to a first privacy level or a higher privacy level. Responsive to determining that the privacy level corresponds to a first privacy level, an embodiment may perform a corresponding function associated with the audible command without authenticating the user. Responsive to determining that the privacy level corresponds to a higher privacy level, an embodiment may first authenticate a user prior to performing a corresponding function. Such techniques may allow for quicker processing of commands that are generally non-sensitive while still ensuring that functions associated with commands that are sensitive and/or confidential may only be processed if provided by an authorized user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an audible command from a user;
determining, using a processor, whether a privacy level associated with the audible command corresponds to one of a first privacy level and a higher privacy level; and
responsive to determining that the privacy level corresponds to the higher privacy level, authenticating the user prior to performing a function associated with the audible command.

2. The method of claim 1, wherein the determining comprises accessing a list of stored domains, each of the stored domains being associated with a first privacy level or a higher privacy level.

3. The method of claim 2, further comprising:
determining whether the audible command comprises at least one domain from the list;
assigning, based on the determined at least one domain, a confidence level of user authentication to the audible command; and
identifying whether the confidence level of user authentication assigned to the audible command exceeds a predetermined threshold.

4. The method of claim 1, wherein the authenticating comprises prompting the user to provide user authentication input.

5. The method of claim 4, wherein the user authentication input is at least one input selected from the group consisting of biometric input, password input, and additional voice input.

6. The method of claim 5, further comprising notifying the user that the function cannot be performed responsive to determining that the received user authentication input does not match stored user authentication data.

7. The method of claim 1, wherein the higher privacy level comprises at least two higher privacy levels, each of the at least two higher privacy levels being associated with a confidence level different from any other of the at least two higher privacy levels.

8. The method of claim 7, wherein the authenticating comprises an authentication requirement and further comprises adjusting the authentication requirement based on the confidence level.

9. The method of claim 8, wherein the authentication requirement comprises at least two authentication types.

10. The method of claim 1, further comprising performing, responsive to determining that the privacy level corresponds to the first privacy level, a function associated with the audible command without authenticating the user.

11. An information handling device, comprising:
a processor;
a memory device that stores instructions executable by the processor to:
receive an audible command from a user;
determine whether a privacy level associated with the audible command corresponds to one of a first privacy level and a higher privacy level; and
responsive to determining that the privacy level corresponds to the higher privacy level, authenticate the user prior to performing a function associated with the audible command.

12. The information handling device of claim 11, wherein the instructions executable by the processor to determine comprise instructions executable by the processor to access a list of stored domains, each of the stored domains being associated with a first privacy level or a higher privacy level.

13. The information handling device of claim 12, wherein the instructions are further executable by the processor to:
determine whether the audible command comprises at least one domain from the list;
assign, based on the determined at least one domain, a confidence level of user authentication to the audible command; and
identify whether the confidence level of user authentication assigned to the audible command exceeds a predetermined threshold.

14. The information handling device of claim 11, wherein the instructions executable by the processor to authenticate comprise instructions executable by the processor to prompt the user to provide user authentication input.

15. The information handling device of claim 14, wherein the user authentication input is at least one input selected from the group consisting of biometric input, password input, and additional voice input.

16. The information handling device of claim 11, wherein the higher privacy level comprises at least two higher privacy levels, each of the at least two higher privacy levels being associated with a confidence level different from any other of the at least two higher privacy levels.

17. The information handling device of claim 16, wherein the instructions executable by the processor to authenticate comprise an authentication requirement and wherein the instructions are further executable by the processor to adjust the authentication requirement based on the confidence level.

18. The information handling device of claim 17, wherein the authentication requirement comprises at least two authentication types.

19. The information handling device of claim 11, wherein the instructions are further executable by the processor to perform, responsive to determining that the privacy level corresponds to the first privacy level, a function associated with the audible command without authenticating the user.

20. A product, comprising:
a storage device that stores code, the code being executable by a processor and comprising:
code that receives an audible command from a user;
code that determines whether a privacy level associated with the audible command corresponds to one of a first privacy level and a higher privacy level; and
code that authenticates, responsive to determining that the privacy level corresponds to the higher privacy level, the user prior to performing a function associated with the audible command.
